(19) United States
(12) Patent Application Publication
(10) Pub. No.: US 2013/0074746 A1
(43) Pub. Date: Mar. 28, 2013

(54) METHOD AND APPARATUS FOR REDUCTION OF POLLUTANTS IN COMBUSTION EFFLUENT

(71) Applicant: Terry Higgins, Lees's Summit, MO (US)

(72) Inventor: Terry Higgins, Lees's Summit, MO (US)

(73) Assignee: Power & Industrial Services Corporation, Donora, PA (US)

(21) Appl. No.: 13/348,181

(22) Filed: Jan. 11, 2012

Related U.S. Application Data
(60) Provisional application No. 61/626,311, filed on Sep. 23, 2011.

(51) Int. Cl. F23J 15/04; B08B 3/02; B08B 3/10; B01D 53/56

(52) U.S. Cl. 110/344; 423/235; 110/215; 134/19; 134/22.12; 134/105; 134/167 R

(57) ABSTRACT

Selective non-catalytic reduction (SNCR) of pollutant remissions in a fossil fuel combustion furnace having water cannons installed therein for removing combustion incrustation is accomplished by using the water cannons intended for de-slagging by mixing a reagent with water and administering the mixture under high velocity and high blast flow rate to the interior of the furnace for reduction of pollutant emissions, such as NOx, with the water cannons. The water cannons may be switched from the SNCR function to a de-slagging function.

### CROSS REFERENCE

This patent application claims the benefit of U.S. Provisional Patent Application No. 61/626,311, filed 23 Sep. 2011, the contents of which are incorporated herein by reference.

### BACKGROUND OF THE INVENTION

This invention relates to the reduction of pollutants, such as nitrogen oxide, in combustion effluent of a carbonaceous fuel. More particularly, this invention relates to a process and apparatus to accomplish this.

Selective non-catalytic reduction (SNCR) have been used for many years to reduce the oxides of nitrogen in combustion processes. SNCR has been used for the reduction of NOx to meet regulatory limits by a chemical process in the combustion effluent. This is generally accomplished by the uniform injection of a reagent into the furnace's flue gas combustion stream.

SNCR uses a reagent, either urea or anhydrous ammonia, sprayed directly into the furnace at specified locations to induce a reaction between the reagent and the nitrogen oxide in the flu gas. This reduction reaction produces elemental nitrogen and water vapor from a portion of the NOx pollutant in the gases as well as some other byproducts.

The SNCR reaction is best achieved in locations where the furnace gases are predicted to be 1,800-2,000 degrees F. In order to pinpoint the correct locations, typical SNCR design involves predictive modeling and testing to determine injection locations. In order to cover the large volume and potential locations, typically SNCR injection systems include multiple wall injectors. At each injector location, a furnace wall penetration is required with mounting hardware, piping for the reagent and atomization air. Typically SNCR uses two fluid nozzle technology wherein air is used to atomize the reagent into fine droplets in the furnace.

In addition, in order to meet NOx reduction demands over the load range, the injector array described above may be duplicated at multiple elevations. Different elevations help to provide the reagent injection at variable load points and can help with tuning using the control system. On large boilers where substantial NOx reduction cannot be achieved with raw injectors alone, longer retractable injector nozzles are added that help transport the reagent mixture further into the furnace volume to target an area that cannot be reached with the standard wall injector arrangement. the addition of the long retractable nozzles add substantial capital cost in maintenance with limited return or minimal improvement in NOx reduction.

The remainder of the SNCR system equipment includes the piping and control systems. Pumping, metering and mixing skids are also required to regulate the flow of reagent and the dilution of the reagent from the storage tanks. Storage tanks are typically located outdoors as near to the boiler as practical along with an unloading station, forwarding pumps, a containment basin, etc.

Such SNCR injection systems are exceptionally expensive to install and maintain. It is a principal object of the present invention to eliminate or reduce the requirement of expensive SNCR injection systems for injecting the reagent into the furnace.

### SUMMARY OF THE INVENTION

The SNCR method of the present invention incorporates the use of water cannons already installed in the combustion chamber of the furnace or boiler for removing combustion incrustation to deliver the SNCR reagent. The industry previously considered the use of water cannons for the delivery of a reagent as being unsuitable and impractical.

Conventional furnace wall cleaning involves multiple penetrations with each containing hardware to blow steam or air through a small nozzle on the end of a retractable lance back at the adjacent wall to clean furnace deposits. On a large utility burner, fifty or more of these soot blowers were typically installed. All this equipment added significant cost, piping, air or steam requirements, and many long term maintenance dollars.

Water cannon technology was developed as a way to eliminate much of the furnace cleaning equipment, reduce overall costs, improve cleaning and lower overall cost of operation. This technology has been in use in the US for the last ten to fifteen years. Water cannon equipment has been developed and supplied by both Clyde Bergemann, referred to as a water cannon, and Diamond Power, referred to as the Hydrojet. These systems are slightly different but the overall approach and technology is the same.

A water cannon system consists of a penetration through the water walls of the furnace, many times one per wall of the furnace. Each location includes a lance with external hardware that allows the lance to be indexed and moved when in operation to direct the water jet and trace out the pattern of the area to be cleaned. The jet sprays a tight steam of water with a high blast exit velocity and a high blast flow rate across the furnace to the opposite or adjacent wall and is manipulated as described to clean a designated area. The balance of the system includes a pump skid to boost surface water pressure to meet flow and pressure demands of the lance and cleaning needs. An automated control system is provided to run the control drives on the lance, monitor wall conditions using embedded furnace wall heat flux sensors, and allow sequencing and timing of cleaning events. The operation of the water jet is at conditions that provide a concentrated stream of water that will traverse the furnace when the broiler is in operation and contains enough flow and pressure to maintain a tight stream all the way to the area to be cleaned.

The water cannon was developed as a way to eliminate dozens of wall soot blowers, reduce maintenance and improve cleaning across a large furnace cavity. SNCR limitations and drawbacks has to do with multiple penetrations, difficulty in delivering the reagent to a large furnace and achieving the desired results. The larger the furnace and the more operating modes, the more complex and costly the SNCR system becomes. The process and apparatus of the present invention combines these two technologies of SNCR delivery and water cannons into a system that uses the best features of both technologies to deliver cost effective NOx reduction. This is contrary to the beliefs and understandings of the industry that this was not possible or practical because of the significantly higher flow of water into the boiler, heat rate penalty and fan impacts encountered with water cannons. The inventor discovered that the flow of water required per water cannon lance is substantially identical to the total flow of reagent to water solution on a conventional SNCR injection system. What was confirmed by the inventor is that with the right dilution of reagent in water, the present invention can put the same amount of reagent into a boiler as a typical SNCR system of lances with the same amount of water. The concern or belief that the flow rates of water cannons are so significantly different that SNCR administration could not be achieved without significant changes to the typical water cannon equipment, proved to be false.

The conventional water cannon injection lance has a nozzle designed for pressure and flow that will result in a tight stream of fluid with enough energy to penetrate the furnace gases and reach the far wall without losing all the energy needed to perform the cleaning duty. The nozzle design for the water cannon utilized in the process of the present invention uses high pressure and high flow to deliver a dense fog like spray pattern that can be aimed and adjusted as needed to tune the NOx reduction. The goal of the injection is not to shoot a stream across the furnace volume but rather to direct a large spray out into the hot furnace gases with enough energy to reach the location for maximum reagent utilization. The reagent concentration, flow rate, pressure and spray pattern are regulated to achieve the intended results. The balance of the system of the present invention is a combination of the standard water cannon auxiliaries for piping, pumping and controls along with the standard SNCR system for reagent unloading, storage, dilution, piping and controls required to achieve the supply requirements.

The process design of the present invention includes temperature mapping of the boiler over the operating range. The use of computational fluid dynamic modeling of the furnace with integration of test data is used in the design, with integration of advanced instrumentation with the system control for long term optimization. Systems for in situ monitoring of furnace exit gas temperature, real time NOx and CO measurement are used to improve efficiency and reagent utilization, while minimizing any impact on boiler performance and overall heat rates.

The reagent (urea or ammonia) is mixed 2 to 10% by volume with water and the mixture is administered under high velocity and high blast flow rate to the interior of the furnace or boiler for reduction of pollutant emissions with the water cannons. Typical water cannon blast exit velocity is regulated to be 20 feet per second to 400 feet per second and typical blast flow rate is regulated to be 10 to 400 gallons per minute.

The water cannons are provided with nozzles which have spray patterns which are adjusted by changing spray tips in order that the nozzles may be adjusted to provide an optimum spray pattern for SNCR. The spray patterns and nozzle adjustments could also be remotely controlled by computer control as are other operating parameters of the water cannons. In addition, only selected water cannons may be utilized as desired or required.

Also another important feature of the present invention is that the water cannons may be readily switched from an SNCR function to a de-slagging function, switching from a reagent mixture to a de-slagging compound and otherwise remotely controlling the spray pattern and nozzle spray configuration of the selected water cannons.

Another advantage of the system of the present invention is that the water cannons are positioned at a more accessible lower location in the boiler than sprayers in typical SNCR injection systems. Also, instead of a conventional retractable injection lance that has a set spray pattern and a set elevation, the system of the present invention provides an SNCR injection system wherein one is able to point the water cannon where needed and adjust the spray pattern, and the system can be quickly switched for spraying a de-slagging compound thereby eliminating the need for expensive SNCR injection systems. The end result is a simple, robust, flexible, and cost effective alternative for boiler operators and owners for NOx reduction goals.

The unique features of the method and apparatus of the present invention as compared to the competing technology suppliers, is fewer but larger injection lances, aiming capability of the lance, integration of the targeting with operation, enhancement with advanced incrementation for furnace effluent gas temperature control, slag deposition reduction, and more effective control of NOx. Potential further enhancement includes the addition of other chemical compounds, such as magnesium hydroxide, ammonia hydroxide, or other chemical compounds, or suspension mixtures based on future research in this area.

### BRIEF DESCRIPTION OF THE DRAWINGS

Other objects and advantages appear hereinafter in the following description and claims. The accompanying drawings show, for the purpose of exemplification, without limiting the scope of the invention or the appended claims, certain practical embodiments of the present invention, wherein:

FIG. 1 is a process schematic diagram illustrating the method and apparatus of the present invention; and

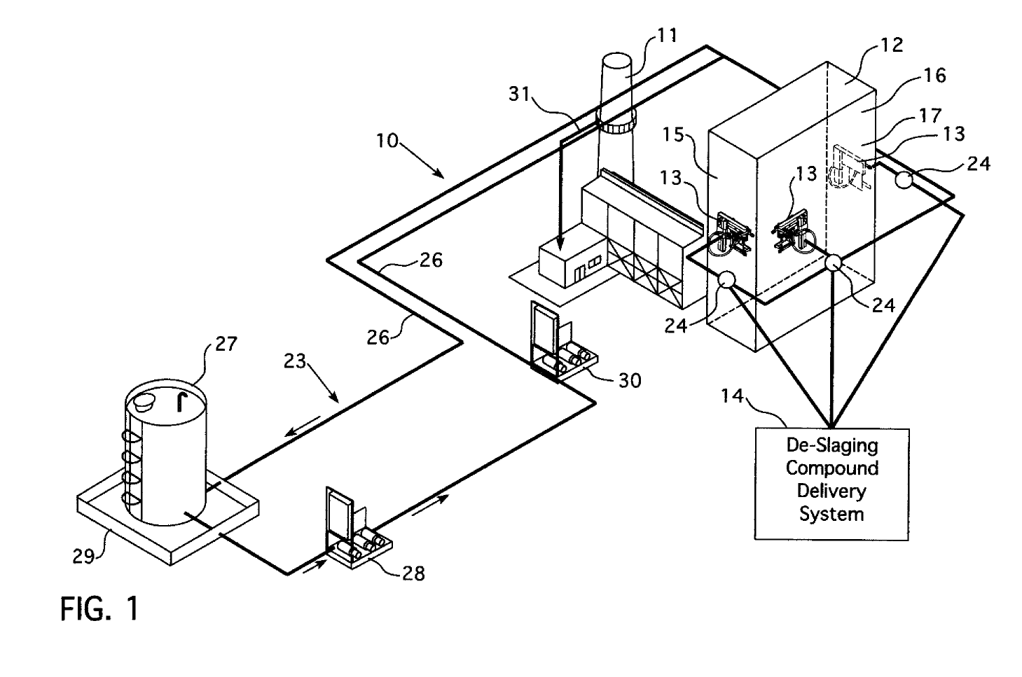

FIGS. 2 and 3 are respectively a side and rear isometric view with parts removed of a water cannon assembly adapted for the method and apparatus of the present invention.

### DETAILED DESCRIPTION OF THE PREFERRED EMBODIMENTS

Referring to the drawings, the apparatus 10 of the present invention is illustrated for selective non-catalytic reduction (SNCR) of pollutant emissions in fossil fuel combustion effluent emanating from stack 11 of fossil fuel combustion furnace 12 having articulatable water cannons 13 installed for removing combustion incrustation in the furnace 12. Water cannons 13 are connected to a source of de-slagging compound from a conventional de-slagging compound delivery system 14 under high pressure for injection by water cannons 13 into furnace 12.

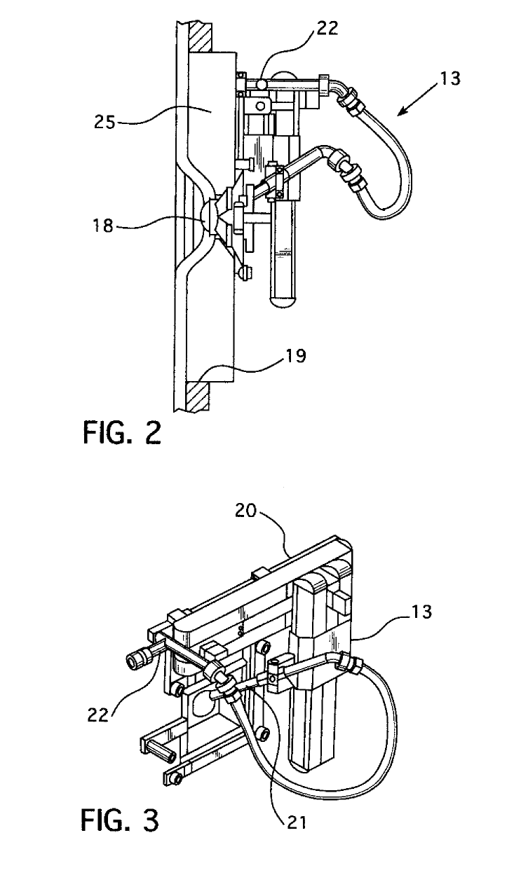

As is better illustrated in FIGS. 2 and 3, the water cannons 13 in this embodiment are provided in walls 15 and 17 of furnace 12. Each of the water cannons 13 includes an adjustable nozzle 18 positioned within wall box 25 mounted in wall port 19 of furnace 13 in order to project a stream of fluid, such as water with a de-slagging compound, into the interior volume of the furnace 13. Nozzle 18 includes a ball pivot joint as illustrated to permit adjustment of the direction of the stream of fluid by remote manipulation of external hardware 20 that allows the lance 21 to be indexed in the X and Y directions in a conventional manner to direct the water jet and trace out the preprogrammed pattern of the area to be cleaned. The adjustable nozzle 18 sprays a tight stream of water for water mixture across the furnace to the opposite or adjacent wall and is moved in a programmed manner to clean a designated area as with, for example, a CNC control.

Water cannons 13 are also alternatively connected to a mixture of reagent and water under high pressure through supply pipes 22 to a mixture of reagent and water under high pressure supplied from system 23 whereby the water cannons 13 may be selectively switched from a de-slagging function to an SNCR function with solenoid operated switching valves 24.

The SNCR system 23 includes piping 26 and control systems conventionally provided for de-slagging systems, including a storage tank 27 for storing the reagent urea or anhydrous ammonia in concentrated form, circulation skid at 28 for circulating the reagent in pipes 26, a containment basement 29 for spill protection, and a pumping, metering and mixing skid 30 for mixing and metering the reagent in the desired amount with the water and delivering the mixture under high pressure to the water cannons 13.

As with de-slagging, pollutant emissions are continuously monitored by monitor 31 for feedback with conventional automated control to a conventional automated control system that is provided to run the control drives on the lance, monitor wall conditions using embedded furnace wall heat flux sensors, and providing sequencing and timing of SNCR and cleaning events and for also remotely adjusting nozzles 18 of water cannons 13 to provide an optimum spray pattern for SNCR.

As previously explained, the most prevalent pollutant in the affluent emissions is NOx and the typical reagent is either urea or anhydrous ammonia.

The water cannons 13 are remotely articulated for selective aiming of the spray and selecting an optimum pattern of the spray ejected from the water cannons to provide pollutant reduction through the use of conventional automated control techniques already in place for manipulation of the water cannon 13 for de-slagging functions, with the exception that the water cannon nozzles 18 for the method and apparatus of the present invention are also provided with remotely adjustable nozzles for additionally providing adjustment of the spray patterns.

I claim:

1. The method of selective non-catalytic reduction (SNCR) of pollutant emissions in a fossil fuel combustion furnace having water cannons installed for removing combustion encrustation, comprising;
mixing a reagent with water and administering said mixture under high velocity and high blast flow rate to the interior of said furnace for reduction of pollutant emissions with said water cannons.

2. The method of claim 1, wherein said pollutant emissions include NOx and said reagent is urea or ammonia.

3. The method of claim 2, wherein said mixture is 2 to 10% by volume of reagent to water.

4. The method of claim 2, wherein said water cannons are provided with a blast exit velocity of 20 feet per second to 400 feet per second and a blast flow rate of 10 to 400 gallons per minute.

5. The method of claim 4, wherein said water cannons are provided with nozzles having adjustable spray patterns and said nozzles are adjusted to provide an optimum spray pattern for SNCR.

6. The method of claim 4, wherein only selected of said water cannons are utilized.

7. The method of claim 4, including the step of switching said water cannons to spray a de-slagging compound.

8. The method of claim 7, wherein said de-slagging compound is selected to include ammonia hydroxide.

9. The method of claim 4, including the step of selectively articulating said water cannons to provide maximum SNCR.

10. An apparatus for selective non-catalytic reduction (SNCR) of pollutant emissions in fossil fuel combustion effluent, comprising;
a fossil fuel combustion furnace having articulatable water cannons installed for removing combustion encrustation in said furnace, said water cannons connected to a source of a de-slagging compound under high pressure for injection by said water cannons into said furnace;
said water cannons also alternatively connected to a mixture of reagent and water under high pressure whereby selected of said water cannons may be switched form a de-slagging function to an SNCR function.

11. The apparatus of claim 10, wherein said pollutant emissions include NOx and said reagent is urea or ammonia.

12. The apparatus of claim 11, wherein said mixture is 2 to 10% by volume of reagent to water.

13. The apparatus of claim 12, wherein said high pressure is sufficient to provide said water cannons with a blast exit velocity of 20 feet per second to 400 feet per second and a blast flow rate of 10 to 400 gallons per minute.

14. The apparatus of claim 13, wherein said water cannons have adjustable nozzles for adjusting their spray patterns whereby said nozzles are adjusted to provide an optimum spray pattern for SNCR.

15. The apparatus of claim 13, wherein said de-slagging compound includes ammonia hydroxide.

16. The apparatus of claim 13, wherein said water cannons are remotely articulatable for selective aiming of spray ejected from said water cannons.
